(19) United States
(12) Patent Application Publication
(10) Pub. No.: US 2010/0020749 A1
(43) Pub. Date: Jan. 28, 2010

(54) METHOD OF DOWNLINK PACKET TRANSMISSION CONTROL IN MOBILE COMMUNICATIONS SYSTEM

(76) Inventors: Jae-Wook Shin, Daejon (KR); Ae-Soon Park, Daejon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/517,758

(22) PCT Filed: Nov. 29, 2007
(86) PCT No.: PCT/KR07/06106

§ 371 Date: Jun. 4, 2009

(30) Foreign Application Priority Data
Dec. 4, 2006 (KR) 10-2006-0121217
May 14, 2007 (KR) 10-2007-0046720

(51) Int. Cl. H04W 40/00

(52) U.S. Cl. 370/328

(57) ABSTRACT

Provided is a method of downlink packet transmission control in a mobile communication system. The method includes the steps of: a) establishing a default bearer when a downlink packet is received; b) determining whether a downlink packet filter corresponding to a downlink packet exists or not; c) transferring the downlink packet through the default bearer if the corresponding downlink packet filter does not exist; and d) transferring the downlink packet through a dedicated bearer if the corresponding downlink packet filter exists.

### TECHNICAL FIELD

The present invention relates to a method of downlink packet transmission control in a mobile communication system; and, more particularly, to a method of downlink packet transmission control in a mobile communication system to transfer downlink packet selectively using one of a default bearer and a dedicated bearer according to whether a downlink packet filter corresponding to a downlink packet exists or not.

This work was supported by the IT R&D program for MIC/IITA [2005-S-404-32, “Research & development on Mobile Terminal Technology based on 3G Evolution”].

### BACKGROUND ART

Throughout the specification, a mobile communication system denotes a mobile communication system including a 3^{rd} Generation Evolution (3GE) mobile communication system of a 3^{rd} generation partnership project (3GPP). Throughout the specification, a 3GE mobile communication system will be described as an example. However, the present invention is not limited thereto.

The 3GE mobile communication system employs a default bearer for quickly controlling various packet services and conveniently managing the quality of a service. Upper layer service context information for the default bearer is generated when a terminal is initially registered at a network. If a terminal is already registered at a network, the upper layer service context information for the default bearer is always available to a terminal and a network regardless of whether the signaling connection between the terminal and the network is established or not.

Resources for a default bearer are allocated when the signaling connection between a terminal and a network is established. When the signaling connection is released, corresponding resources are released too. An IP signaling packet such as an internet control message protocol (ICMP), an IP application signaling packet such as a session initiation protocol (SIP), or an internet protocol (IP) packet having a ‘best-effort’ type service quality, such as a E-mail are transmitted through a default bearer.

A terminal can transmit a plurality of packet services at the same time. Each of the packet services is constituted of more than one of packet flows, and each of the packet flows corresponds to one of a dedicated bearer and a default bearer according to the characteristics thereof.

When a network receives a downlink packet to be transmitted to a terminal in an IDLE state, the network searches a target terminal by performing a paging process and establishes a signaling connection between the target terminal and the network.

The 3GE mobile communication system employing the default bearer needs to establish a default bearer as well as establishing the signaling connection between the terminal and the network when paging the terminal.

Also, a downlink packet initiating the paging process can be transmitted to a terminal selectively through one of a default bearer and a dedicated bearer. If the downlink packet is transmitted through the dedicated bearer, it is required to additionally perform a process for establishing a corresponding dedicated bearer.

Therefore, a method of downlink packet transmission control in consideration of a default bearer is introduced in the present invention.

### DISCLOSURE OF INVENTION

### Technical Problem

An embodiment of the present invention is directed to providing a method of downlink packet transmission control in a mobile communication system in order to effectively transfer a downlink packet by transferring a downlink packet selectively through one of a default bearer and a dedicated bearer according to whether a downlink packet filter corresponding to a downlink packet exists or not.

Another embodiment of the present invention is directed to providing a method of downlink packet transmission control in a mobile communication system in order to effectively transfer a downlink packet by establishing a default bearer of a terminal and paging a terminal when a downlink packet is arrived at a network from a terminal, selecting one of a default bearer and a dedicated bearer to transmit a corresponding downlink packet based on a terminal access state, downlink packet filter information, default and dedicated bearer information, controlling the establishing of a dedicated bearer according to the determination result, and transmitting the downlink packet through the selected bearer.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method of downlink packet transmission control in a mobile communication system, including the steps of: a) establishing a default bearer when a downlink packet is received; b) determining whether a downlink packet filter corresponding to a downlink packet exists or not; c) transferring the downlink packet through the default bearer if the corresponding downlink packet filter does not exist; and d) transferring the downlink packet through a dedicated bearer if the corresponding downlink packet filter exists.

### Advantageous Effects

A downlink packet is transmitted by selectively one of a default bearer and a dedicated bearer according to whether a downlink packet filter corresponding to a downlink packet exists or not in the present invention. Therefore, the downlink packet is effectively transferred.

### BRIEF DESCRIPTION OF THE DRAWINGS

FIG. 1 is a diagram illustrating a 3^{rd} Generation Evolution (3GE) mobile communication system where the present invention is applied.

FIG. 2 is a diagram illustrating a default bearer of a 3GE mobile communication system in accordance with an embodiment of the present invention.

FIG. 3 is a flowchart describing a method of downlink packet transmission control in a mobile communication system in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

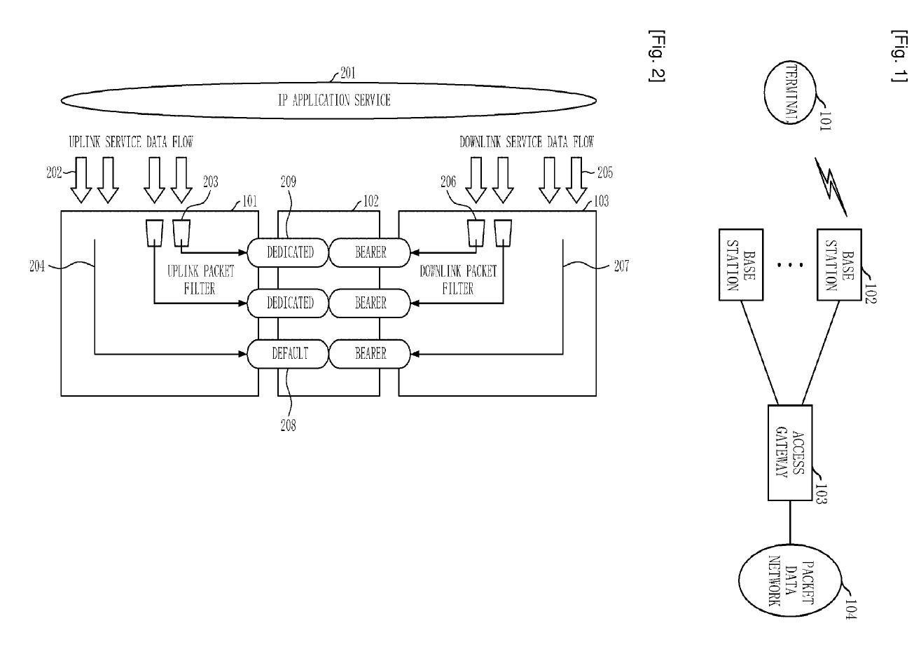

FIG. 1 is a diagram illustrating a 3^{rd} Generation Evolution (3GE) mobile communication system where the present invention is applied.

As shown in FIG. 1, the 3GE mobile communication whether the present invention is applied includes a terminal or user equipment (UE) 101, a base station or an Evolved NodeB (eNB) 102, and an access gateway (aGW) 103.

The terminal 101 accesses the base station 102 through a wireless interface. The base station 102 accesses the access gateway 103 through a wired interface. The access gateway 103 interoperates with an external packet data network (PDN) through an Internet Protocol (IP) interface.

The terminal 101 performs an IP based packet service with a server in a packet data network 104 or a corresponding node. In order to transmit an IP packet, it is required to establish a bearer among the terminal 101, the base station 102, and the access gateway 103.

FIG. 2 is a diagram illustrating a default bearer of a 3GE mobile communication system in accordance with an embodiment of the present invention.

As shown in FIG. 2, the terminal 101 can perform a plurality of IP application services 201 at the same time. Each of the IP application services 201 includes more than one of uplink (UL) service data flows 202 and downlink (DL) service data flows 205.

The UL service data flows 202 correspond to corresponding uplink packet filters 203. Each of the uplink packet filters 203 corresponds to a default bearer 208 or a dedicated bearer 209. That is, uplink packets generated at the terminal 101 by an application service is classified into the UL service data flow 202 according to the information of the UL packet filter 203 sustained by the terminal 101. Then, the generated uplink packet is transmitted to the base station 102 through a corresponding bearer.

On the contrary, a downlink packet received at the access gateway 103 is classified into a DL service data flow 205 according to the information about the downlink packet filter 206. Then, the classified packet is transferred to the base station 102 through a corresponding bearer.

The base station 102 performs a function for corresponding wired/wireless bearers to each other between the terminal 101 and the access gateway 103. The bearer includes a dedicated bearer 209 and a default bearer 208. Packets matched to the uplink/downlink packet filters 203 and 206 are transmitted through the dedicated bearer 209. Packets not matched to the uplink/downlink packet filters 203 and 206 are transmitted through the default bearer 208.

A packet transferred through the default bearer 208 is a packet not demanding a strict quality of a service, for example, an IP signaling packet such as an internet control message protocol (ICMP), an IP application signaling packet such as a session initiation protocol (SIP), or an internet protocol (IP) packet having a ‘best-effort’ type service quality such as a E-mail.

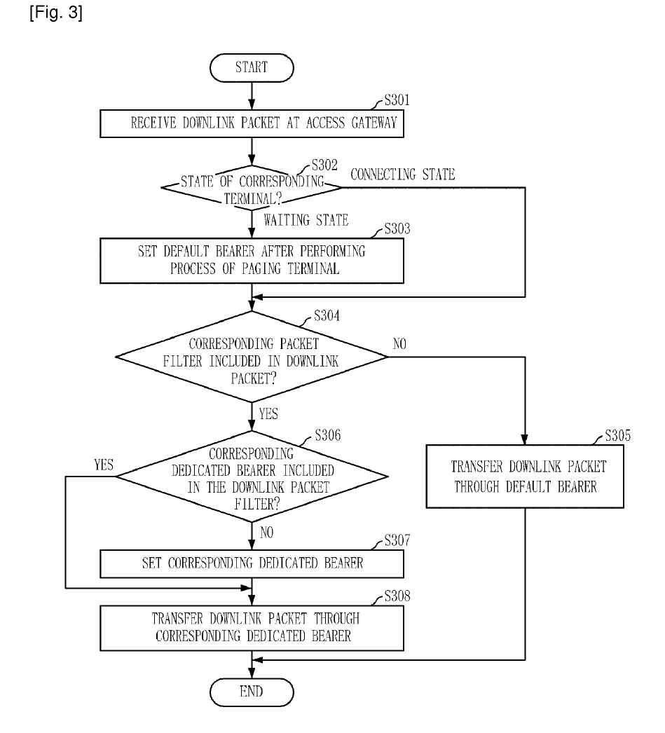

FIG. 3 is a flowchart describing a method of downlink packet transmission control in a mobile communication system in accordance with an embodiment of the present invention.

At step S301, a network, that is, an access gateway 103, receives a downlink packet to be transmitted to a terminal 101.

At step S302, the access gateway 103 checks the state of a corresponding terminal 101.

If the terminal 101 is in an IDLE state at the step S302, the signaling-connection is not established between the terminal and the network. Accordingly, the access gateway 103 performs a paging process for paging the terminal 101 and establishes a default bearer among the terminal 101, the base station 102 and the access gateway 103 at step S303.

Since the paging process is widely known technology, the detailed description thereof is omitted. The default bearer establishing process includes a process of establishing a default bearer from at least one of default bearers.

If the terminal 101 is in a connection state at the step S302, step S304 is performed because the terminal 101 can use the pre-established default bearer.

Then, the access gateway 103 determines whether a downlink packet filter corresponding to a downlink packet exists or not at step S304.

If the downlink packet filter corresponding to the downlink packet does not exist at step S304, the downlink packet is transmitted through the default bearer at step S305.

If the downlink packet filter exists at the step S304, the access gateway 103 determines whether a dedicated bearer corresponding to the downlink packet filter exists or not at step S306.

If the dedicated bearer does not exist at the step S306, a corresponding dedicated bearer is established and the downlink packet is transferred through the established dedicated bearer at steps S307 and S308. If the dedicated bearer exists at step S306, the downlink packet is transferred through the dedicated bearer at step S308.

As described above, a downlink packet can be effectively transferred by establishing a default bearer of a terminal and performing a paging process for paging a terminal when a downlink packet is arrived at a network from a terminal, selecting one of a default bearer and a dedicated bearer to transit a corresponding downlink packet according to a terminal access state, downlink packet filter information, default and dedicated bearer information, controlling the establishing of a dedicated bearer according to the determination result, and transmitting the downlink packet through the selected bearer.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application Nos. 2006-0121217, and 2007-0046720, filed in the Korean Intellectual Property Office on Dec. 4, 2006, and May 14, 2007, respectively, the entire contents of which are incorporated herein by reference.

While the present invention has been described with respect to certain preferred embodiments, it will be apparent to those skilled in the art that various changes and modifications may be made without departing from the spirits and scope of the invention as defined in the following claims.

1. A method of downlink packet transmission control in a mobile communication system, comprising the steps of:
a) establishing a default bearer when a downlink packet is received;
b) determining whether a downlink packet filter corresponding to a downlink packet exists or not;
c) transferring the downlink packet through the default bearer if the corresponding downlink packet filter does not exist; and
d) transferring the downlink packet through a dedicated bearer if the corresponding downlink packet filter exists.

2. The method of claim 1, wherein in the step a), it is determined whether a default bearer is established or not according to a terminal access state.

3. The method of claim 2, wherein the step a) includes the steps of:
a1) receiving a downlink packet to be transmitted to a terminal;
a2) checking a state of the terminal;
a3) detecting a pre-established default bearer if the terminal is in a connection state; and
a4) establishing a default bearer if the terminal is in an idle state.

4. The method of claim 3, wherein in the step a4), a default bearer is established after performing a paging process for paging the terminal.

5. The method of claim 1, wherein the step d) includes the steps of:
d1) transmitting the second downlink packet;
d2) determining whether a dedicated bearer corresponding to the downlink packet filter exists or not if the downlink packet filter corresponding the to the downlink packet exists;
d3) establishing a corresponding dedicated bearer if the corresponding dedicated bearer does not exist, and transferring the downlink packet through the established dedicated bearer; and
d4) transferring the downlink packet through the corresponding dedicated bearer if the corresponding dedicated bearer exists.

6. The method of claim 5, wherein a packet transmitted through the default bearer is one of an IP signaling packet such as an internet control message protocol (ICMP), an IP application signaling packet such as a session initiation protocol (SIP), or an internet protocol (IP) packet having a ‘best-effort’ type service quality, such as an E-mail.

7. The method of claim 5, wherein the mobile communication system is a 3^{rd} generation evolution (3GE) mobile communication system.
